(19) United States
(12) Patent Application Publication
(10) Pub. No.: US 2006/0177026 A1
(43) Pub. Date: Aug. 10, 2006

(54) Telephone exchange and communication terminal

(75) Inventor: Hiromune Suetsugu, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/339,525

(22) Filed: Jan. 26, 2006

(30) Foreign Application Priority Data
Jan. 27, 2005 (JP) 2005-019057

(51) Int. Cl. H04M 11/00

(52) U.S. Cl. 379/90.01

(57) ABSTRACT

A telephone exchange is connected to a communication terminal installed in a predetermined region through a network. The telephone exchange includes: a reference time acquisition unit that acquires a reference time; a storage unit that stores time difference information concerning a time difference between a local standard time of the standard time in the predetermined region and the reference time acquired by the reference time acquisition unit; a local time calculation unit that calculates a local time of the time in the predetermined region based on the reference time obtained by the reference time acquisition unit and the time difference information stored in the storage unit; and a communication unit that transmits the local time calculated by the local time calculation unit to the communication terminal.

### CROSS-REFERENCE TO RELATED APPLICATIONS

This application is based on and claims the benefit of priority from the prior Japanese Patent Application No. 2005-019057, filed on Jan. 25, 2005; the entire contents of which are incorporated herein by reference.

### BACKGROUND

1. Technical Field

This invention relates to a telephone exchange for reporting time information and a communication terminal for displaying the time based on the time information received from the telephone exchange.

2. Description of the Related Art

In recent years, a telephone exchange system has had various service functions. Among them, various time services are available and a specified-time call function represented by morning call, a current time display function on an extension communication terminal with a display, and the like can be used. (For example, refer to JP-A-11-205833.)

On the other hand, in a recent telephone exchange system using IP (Internet Protocol) communications, for example, the flexibility of locations of the telephone exchange system is high because of the communication control method, and the country where a telephone exchange is installed may differ from the country where a telephone communication terminal is installed.

### SUMMARY

However, when the region where a telephone exchange is installed may differ from the region where a telephone terminal is installed, if the time information of the telephone exchange is used as the reference, accurate time information cannot be displayed on the telephone terminal because of the time difference between the locations of the telephone exchange and the telephone terminal; this is a problem. The telephone exchange system described in patent document 1 can display the local time of the called telephone terminal, but does not consider the case where the telephone exchange and the telephone terminal are installed in different regions.

The present invention has been made in view of the above circumstances and provides a telephone exchange system capable of displaying the correct time on a communication terminal when a telephone exchange and the communication terminal are installed in different regions.

To the end, according to an aspect, a telephone exchange is connected to a communication terminal installed in a predetermined region through a network. The telephone exchange comprises: a reference time acquisition unit that acquires a reference time; a storage unit that stores time difference information concerning a time difference between a local standard time of the standard time in the predetermined region and the reference time acquired by the reference time acquisition unit; a local time calculation unit that calculates a local time of the time in the predetermined region based on the reference time obtained by the reference time acquisition unit and the time difference information stored in the storage unit; and a communication unit that transmits the local time calculated by the local time calculation unit to the communication terminal.

According to another aspect, a telephone exchange is connected to a communication terminal installed in a predetermined region through a network. The telephone exchange comprises a reference time acquisition unit that acquires a reference time; a storage unit that stores time difference information concerning the time difference between the local standard time of the standard time in the predetermined region and the reference time acquired by the reference time acquisition unit; and a communication unit that transmits the reference time obtained by the reference time acquisition unit and the time difference obtained from the time difference information stored in the storage unit to the communication terminal.

According to still another aspect, a communication terminal is connected to a telephone exchange for transmitting the reference time through a network and installed in a predetermined region. The communication terminal comprises: a reception unit that receives the reference time from the telephone exchange; a storage unit that stores a time difference between the reference time and the local standard time of the standard time in the predetermined region; and a time calculation unit that calculates the local time of the time in the predetermined region based on the reference time acquired by the reception unit and the time difference stored in the storage unit.

### BRIEF DESCRIPTION OF THE DRAWINGS

These and other objects and advantages of this invention will become more fully apparent from the following detailed description taken with the accompanying drawings in which:

FIG. 1 is a drawing to show a configuration example of a telephone exchange system including a telephone exchange and a telephone terminal according to a first embodiment;

FIG. 2 is a block diagram to show the configuration of the telephone exchange according to the first embodiment;

FIG. 3 is a drawing to show an example of time difference information according to the telephone exchange according to the first embodiment;

FIG. 4 is a drawing to show an example of a display screen displayed on the telephone terminal by the telephone exchange according to the first embodiment;

FIG. 5 is a flowchart to show a processing flow of the telephone exchange according to the first embodiment in displaying the time on the telephone terminal;

FIG. 6 is a drawing to show a configuration example of a telephone exchange system including a telephone exchange and a telephone terminal according to the first embodiment;

FIG. 7 is a block diagram to show the configuration of a telephone exchange according to a second embodiment;

FIG. 8 is a drawing to show an example of terminal information according to the second embodiment;

FIG. 9 is a drawing to show an example of region information according to the second embodiment;

FIG. 10 is a flowchart to show a processing flow of the telephone exchange according to the second embodiment in displaying the time on the telephone terminal;

FIG. 11 is a block diagram to show the configuration of a telephone terminal according to a third embodiment; and

FIG. 12 is a flowchart to show a processing flow of the telephone terminal according to the third embodiment in displaying the time.

### DESCRIPTION OF THE EMBODIMENTS

A telephone exchange and a communication terminal of the invention will be discussed with reference to the accompanying drawings.

(First Embodiment)

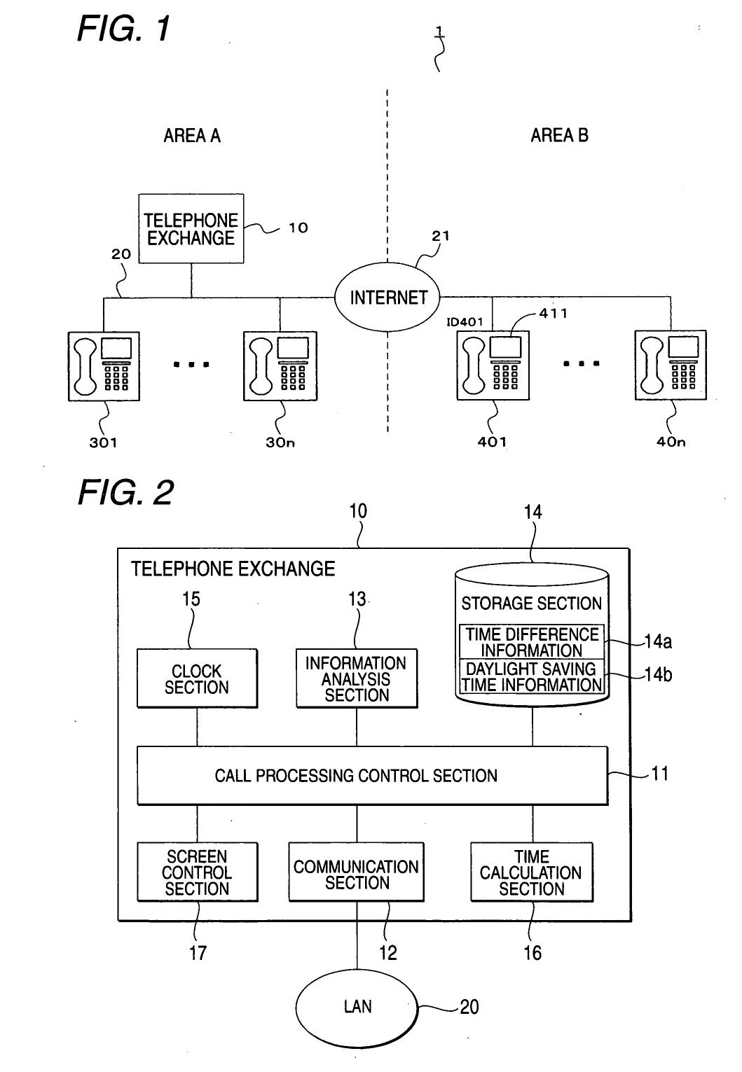

FIG. 1 is a drawing to show a configuration example of a telephone exchange system including a telephone exchange and telephone terminals (communication terminals) of a first embodiment. A telephone exchange system 1 is made up of a telephone exchange 10 installed in area A, telephone terminals 301 to 30n of IP telephone terminals connected to the telephone exchange 10 through a LAN 20, and telephone terminals 401 to 40n connected to the telephone exchange 10 through Internet 21 and installed in area B. The telephone exchange 10 performs telephone exchange processing when the telephone terminals 301 to 30n, 401 to 40n make conversation. The telephone terminal 401 has a display section 411 and the telephone exchange 10 also controls the display section 411 of the telephone terminal 401. It is assumed that the daylight saving time (one hour earlier than the standard time) is applied in both areas A and B from the first Sunday of April to the last Saturday of October. In the description to follow, controlling the telephone terminal 401 by the telephone exchange 10 is taken as an example.

FIG. 2 is a block diagram to show the configuration of the telephone exchange 10. The telephone exchange 10 is made up of a call processing control section 11 for performing conversation processing for the telephone terminal 401 and controlling the whole operation of the telephone exchange 10, a communication section 12 (a communication unit) for communicating with the telephone terminal 401, an information analysis section 13 for acquiring time difference information in accordance with input from the telephone terminal 401, a storage section 14 (a storage unit) for storing time difference information and time period information concerning the time period over which the daylight saving time is applied (from the first Sunday of April to the last Saturday of October), a clock section 15 (a reference time acquisition unit) for acquiring the master time, a time calculation section 16 (a local time calculation unit) for calculating the time (local time) in area B, and a screen control section 17 (a screen control unit) for controlling the display screen 411 of the telephone terminal 401.

The call processing control section 11 performs telephone exchange processing of calling (ringing), etc., for the telephone terminal 401 to make conversation and also controls the whole telephone exchange 10, namely, the communication section 12, the information analysis section 13, the storage section 14, the clock section 15, the time calculation section 16, and the screen control section 17.

The communication section 12 is an interface for communicating with the telephone terminal 401. Not only ordinary conversation data, but also a display screen created by the screen control section 17 is transmitted through the communication section 12 to the telephone terminal 401.

The information analysis section 13 creates time difference information 14a in accordance with input from the telephone terminal 401. For example, the local time of area B where the telephone terminal 401 is installed or the time difference between areas A and B is input from the telephone terminal 401.

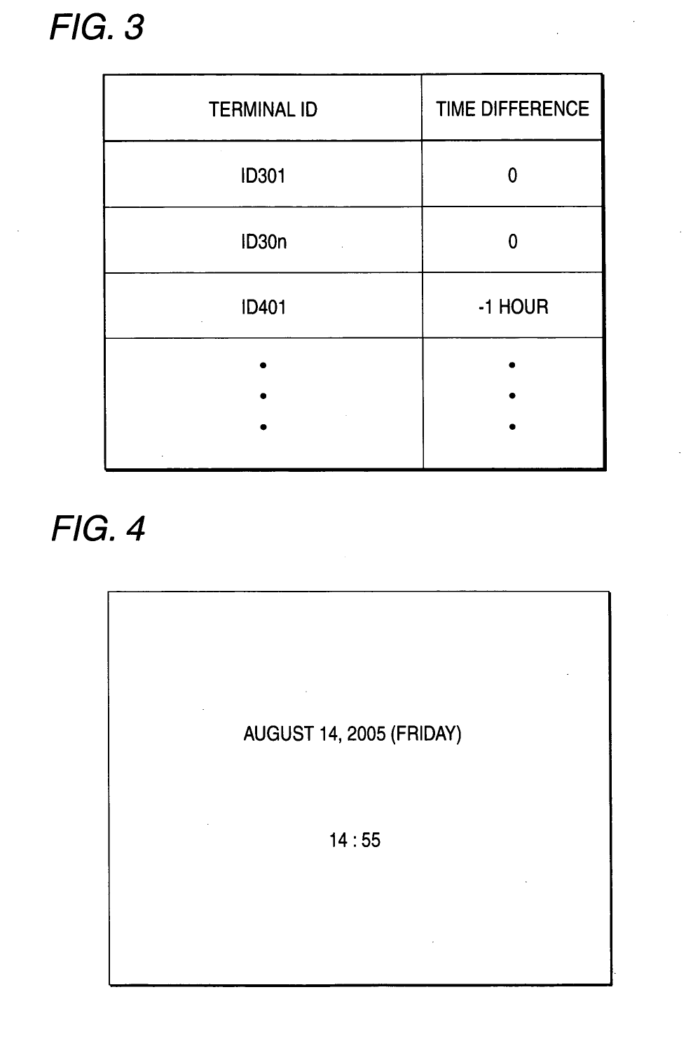

FIG. 3 shows an example of the time difference information 14a. As shown in FIG. 3, the time difference information 14a describes the terminal ID of each telephone terminal and the time difference set for the telephone terminal. In the example in FIG. 3, the time difference is set as 0 hours for the telephone terminals having ID301 and ID30n as the terminal IDs and is set as −1 hour for the telephone terminal having ID401 as the terminal ID. In the description to follow, it is assumed that the terminal ID of the telephone terminal 401 is ID401 and area B has the time difference of −1 hour from area A.

The time difference can be set in 30-minute units from +24 hours to −24 hours. The information analysis section 13 creates the time difference information 14a by rounding the input time difference in 15-minute units to set the time difference in 30-minute units. For example, if the time difference of 35 minutes is input from the telephone terminal 401, the time difference is set as 30 minutes; if the time difference of 48 minutes is input from the telephone terminal 401, the time difference is set as one hour.

The storage section 14 is a nonvolatile storage medium such as an HDD (Hard Disk Drive) or flash memory for storing the time difference information 14a and daylight saving time information 14b. The time difference information 14a is information of the time difference set for each telephone terminal, created by the information analysis section 13, and the daylight saving time information 14b is information concerning the time period over which the daylight saving time is applied. Here, “the first Sunday of April to the last Saturday of October” is set in the daylight saving time information 14b.

The clock section 15 acquires time information including the date from a clock-dedicated chip such as an RTC (real time clock), for example, and ticks the master time (reference time). The clock section 15 shifts the time by −1 hour within the time period of the daylight saving time information 14b (namely, from the first Sunday of April to the last Saturday of October). The time may be able to be input or changed from the telephone terminals 301 to 30n, 401 to 40n. In this case, the time input from the telephone terminal 301 to 30n, 401 to 40n is adopted as the master time of the clock section 15.

The time calculation section 16 calculates the local time of area B where the telephone terminal 401 is installed from the master time obtained from the clock section 15 and the time difference information 14a stored in the storage section 14.

The screen control section 17 controls the display section 411 of the telephone terminal 401 based on the time of area B calculated by the time calculation section 16. FIG. 4 shows an example of a display screen (display screen information) created by the screen control section 17 and displayed on the display section 411 of the telephone terminal 401. Displayed on the display section is 14 hours 55 minutes on Aug. 14, 2005, the time of area B calculated by the time calculation section 16. This display screen is created by the screen control section 17 and is transmitted to the telephone terminal 401 for display on the display section 411. If the screen control section 17 creates such a screen every minute and transmits the screen from the communication section 12, the correct time can always be displayed on the display section 411 of the telephone terminal 401.

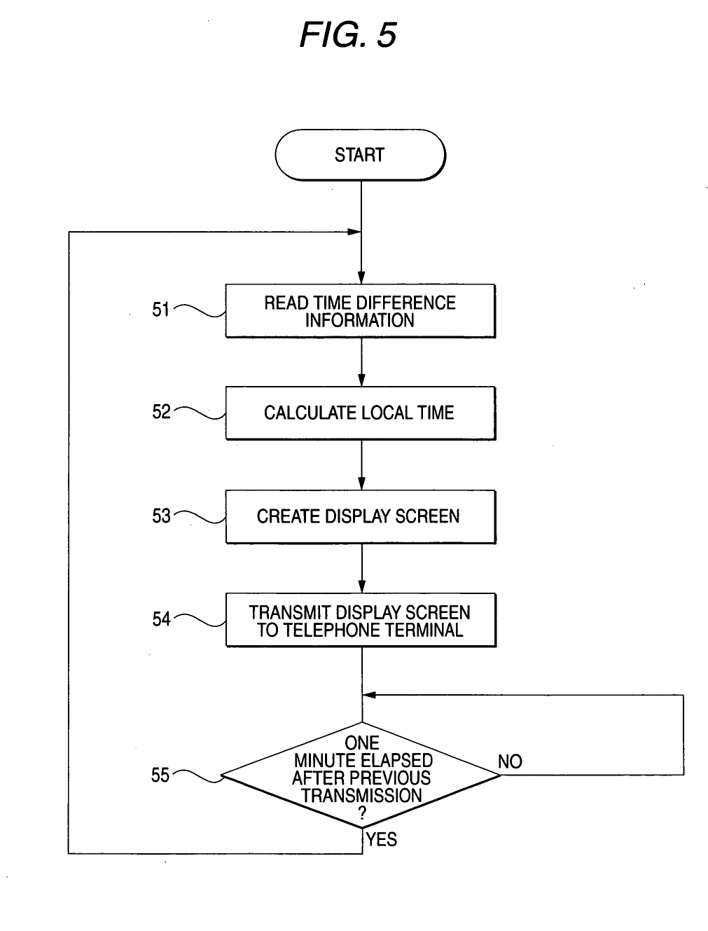

Next, processing of the telephone exchange 10 in displaying the time on the display section 411 of the telephone terminal 401 will be discussed. FIG. 5 is a flowchart to show a processing flow of the telephone exchange 10 in displaying the time on the display section 411 of the telephone terminal 401.

To begin with, the time calculation section 16 reads the time difference information 14a from the storage section 14 (step 51). The time calculation section 16 knows that the time difference of the region where the telephone terminal 401 having ID401 is installed from area B is −1 hour by reading the time difference information 14a.

Next, the time calculation section 16 calculates the local time of area B from the time difference information 14a and the clock section 15 (step 52). For example, if the time obtained from the clock section 15 is 15 hours 55 minutes on Aug. 14, 2005, the local time of area B becomes 14 hours 55 minutes on Aug. 14, 2005 because the time difference information 14a indicates that the time difference from area B is −1 hour. Since the time of the clock section 15 is preset to −1 hour during the time period over which the daylight saving time is applied as described above, the calculated time also becomes the time corresponding to the daylight saving time.

After the local time of the region where the telephone terminal 401 is installed, namely, area B is thus calculated, the screen control section 17 creates a display screen as in FIG. 4 to display the time on the display section 411 of the telephone terminal 401 (step 53). Further, the created screen is sent through the communication section 12 to the telephone terminal 401 for displaying the time on the display section 411 of the telephone terminal 401 (step 54).

After the local time is thus displayed on the display section 411 of the telephone terminal 401, the call processing control section 11 references the clock section 15 and measures the elapsed time. When one minute has not yet elapsed since the preceding transmission (NO at step 55), the telephone exchange 10 waits until the expiration of one minute; when one minute has elapsed (YES at step 55), the telephone exchange 10 returns to step 51.

As described above, according to the first embodiment, the time difference information 14a is previously stored in the storage section 14 and the telephone exchange 10 transmits the time from the communication section 12 to the telephone terminal 401 based on the time difference information 14a, so that the correct local time can be displayed on the display section 411 of the telephone terminal 401.

Further, according to the first embodiment, a display screen is created by the screen control section 17 and is displayed on the display section 411, so that it is made possible to display the local time if the processing capability of the telephone terminal 401 is low.

According to the first embodiment, since the time indicated by the clock section 15 of the telephone exchange 10 is adopted as the master time, a time lag as the whole system can be prevented from occurring. Accordingly, for example, when an error occurs, etc., log analysis, charging, and the like are facilitated.

The daylight saving time information 14b is previously stored in the storage section 14 and the clock section 15 shifts the time during the time period over which the daylight saving time is applied, so that the daylight saving time can also be covered.

In the first embodiment, a display screen is created by the screen control section 17 and is transmitted from the communication section 12, but only the local time may be transmitted from the communication section 12 and a display screen as in FIG. 4 may be created in the telephone terminal 401. In this case, the screen control section 17 is not necessarily required.

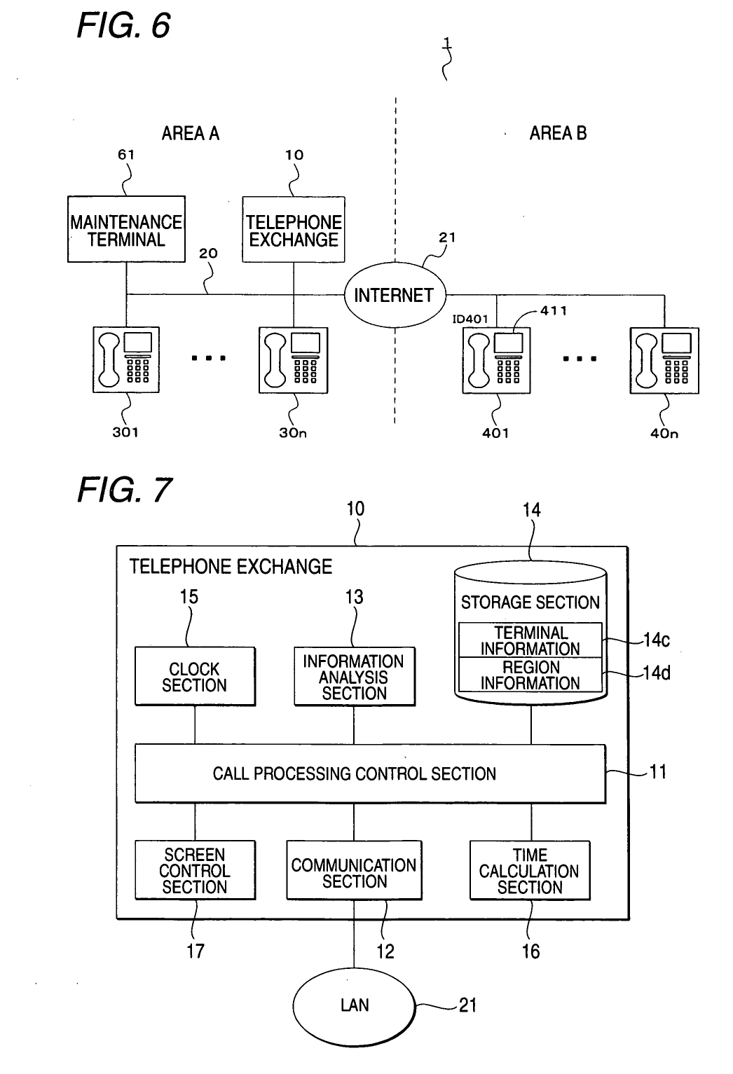

In the first embodiment, the time difference information is input from the telephone terminal 401, but an additional operation section may be provided for enabling the time difference information to be input or a maintenance terminal 61 may be provided on the network (the LAN 20 or the Internet 21) as shown in FIG. 6 for enabling the time difference information to be input.

To provide the maintenance terminal 61 on the network as in FIG. 6, the master time may be able to be input from the maintenance terminal 61 to the telephone exchange 10. In this case, the telephone exchange 10 adopts the time input from the maintenance terminal 61 as the time of the clock section 15.

[Second Embodiment]

Next, a telephone exchange of a second embodiment will be discussed. A telephone exchange system 1 including a telephone exchange 10 and telephone terminals 301 to 30n, 401 to 40n (a communication unit) according to the second embodiment is similar to that of the first embodiment and therefore the configuration of the system will not be discussed again in detail. In the first embodiment, the daylight saving time is applied over the same time period in both areas A and B; in the second embodiment, however, it is assumed that the daylight saving time is not applied in area A and is applied only in area B and that the time period over which the daylight saving time is applied is from the first Sunday of April to the last Saturday of October. In the description to follow, controlling the telephone terminal 401 by the telephone exchange 10 is taken as an example.

FIG. 7 is a block diagram to show the configuration of the telephone exchange 10. The telephone exchange 10 is made up of a call processing control section 11 for performing conversation processing for the telephone terminal 401 and controlling the whole operation of the telephone exchange 10, a communication section 12 for communicating with the telephone terminal 401, an information analysis section 13 for creating terminal information 14c in accordance with input from the telephone terminal 401, a storage section 14 for storing terminal information 14c concerning the region to which the telephone terminal 401 belongs and region information 14d (time difference information) including information concerning the time difference and the daylight saving time for each region, a clock section 15 (a reference time acquisition unit) for acquiring the master time, a time calculation section 16 for calculating the time in area B, and a screen control section 17 (a screen control unit) for controlling the display screen 411 of the telephone terminal 401. The call processing control section 11, the communication section 12, and the screen control section 17 are almost similar to those of the first embodiment and therefore will not be discussed again.

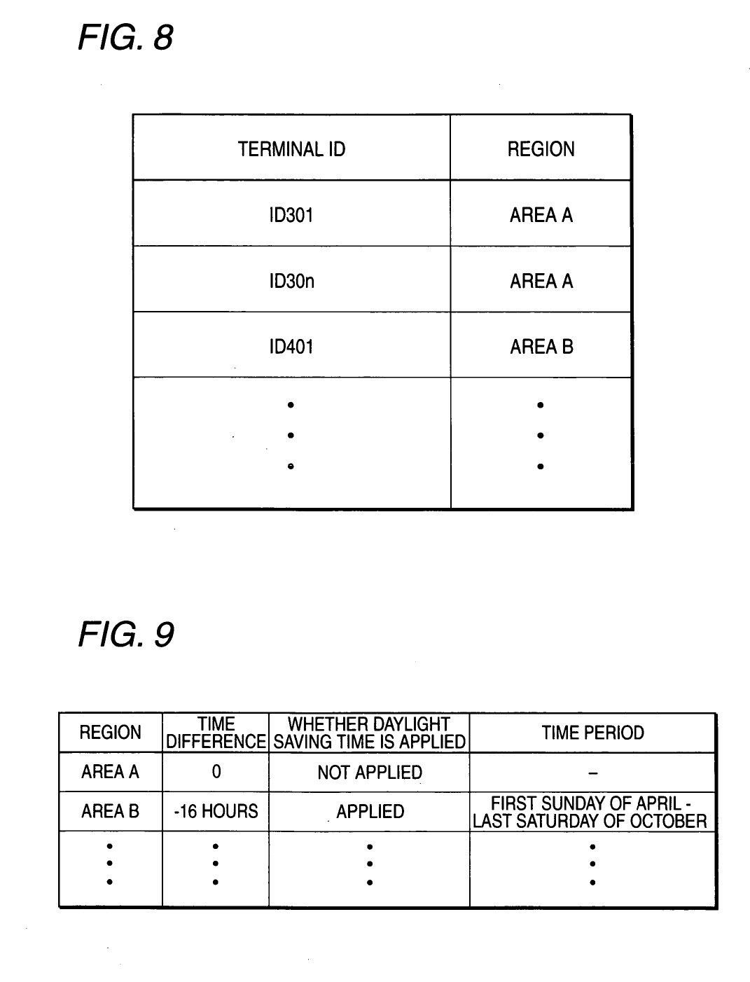

The information analysis section 13 creates terminal information 14c in accordance with input from the telephone terminal 401. The region to which the telephone terminal 401 belongs is specified from the telephone terminal 401 (in the second embodiment, area B). The information analysis section 13 creates the terminal information 14c by associating the input and the ID of the telephone terminal 401 with each other. FIG. 8 shows an example of the terminal information 14c. In the example in FIG. 8, the terminal ID of each telephone terminal and the region to which each telephone terminal belongs are set. In the example in FIG. 8, the telephone terminals having ID301 and ID30n as the terminal IDs are installed in area A and the telephone terminal having ID401 as the terminal ID is installed in area B. In the description to follow, it is assumed that the terminal ID of the telephone terminal 401 is ID401.

The terminal information 14c created by the information analysis section 13 is stored in the storage section 14. In addition to the terminal information 14c, the region information 14d describing the time difference and whether or not the daylight saving time is applied in each region is recorded in the storage section 14. The storage section 14 is a nonvolatile storage medium such as an HDD or flash memory.

FIG. 9 shows an example of the region information 14d stored in the storage section 14. In the example in FIG. 9, it is seen that the time difference from the master time of the clock section 15 does not exist and the daylight saving time is not applied in area A. It is described that the time difference from the master time of the clock section 15 is −16 hours and further the daylight saving time is applied and the time period is from the first Sunday of April to the last Saturday of October in area B.

Referring again to FIG. 7, the clock section 15 acquires time information including the date from a clock-dedicated chip such as an RTC, for example, and ticks the master time (reference time).

The time calculation section 16 calculates the local time of area B where the telephone terminal 401 is installed from the master time obtained from the clock section 15 and the terminal information 14c and the region information 14d stored in the storage section 14.

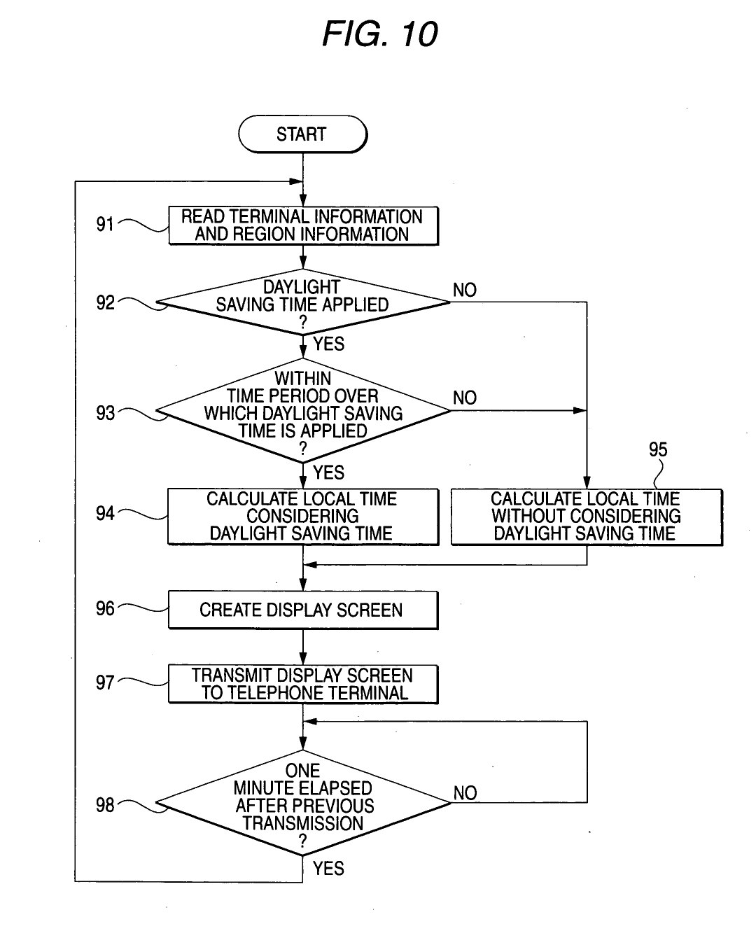

Next, processing of the telephone exchange 10 in displaying the time on the display section 411 of the telephone terminal 401 will be discussed. FIG. 10 is a flowchart to show a processing flow of the telephone exchange 10 in displaying the time on the display section 411 of the telephone terminal 401.

To begin with, the time calculation section 16 reads the terminal information 14c and the region information 14d from the storage section 14 (step 91). The time calculation section 16 knows that the region where the telephone terminal 401 having ID401 is installed is area B. Further, the time calculation section 16 knows that the time difference between the area B time and the master time of the clock section 15 is −16 hour by reading the region information 14d.

Next, the time calculation section 16 determines whether or not the daylight saving time is applied in the region where the telephone terminal 401 is installed (step 92) by referencing the region information 14d. If the daylight saving time is applied in area B (YES at step 92) the time calculation section 16 determines whether or not this day is within the time period over which the daylight saving time is applied (step 93). It is seen that the time period over which the daylight saving time is applied in area B is from the first Sunday of April to the last Saturday of October by referencing the region information 14d.

If this day is within the time period over which the daylight saving time is applied (YES at step 93), the daylight saving time is considered for creating the local time. For example, if the master time of the clock section 15 is 5 hours 55 minutes on Aug. 15, 2005, the local time becomes 14 hours 55 minutes on Aug. 14, 2005 because the time difference is −16 hours and the day is within the time period over which the daylight saving time is applied.

If the daylight saving time is not applied in the region where the telephone terminal 401 is installed (NO at step 92) or if the day is not within the time period over which the daylight saving time is applied (NO at step 93), the time calculation section 16 does not consider the daylight saving time for creating the local time.

After the local time of the region where the telephone terminal 401 is installed, namely, area B is thus calculated, the screen control section 17 creates a display screen as in FIG. 4 to display the time on the display section 411 of the telephone terminal 401 (step 96). Further, the created screen is sent through the communication section 12 to the telephone terminal 401 for displaying the time on the display section 411 of the telephone terminal 401 (step 97).

After the display screen is sent to the telephone terminal 401, the call processing control section 11 references the clock section 15 and measures the elapsed time. When one minute has not yet elapsed since the preceding transmission (NO at step 98), the telephone exchange 10 waits until the expiration of one minute; when one minute has elapsed (YES at step 98), the telephone exchange 10 returns to step 91.

According to the second embodiment, the correct time can be displayed on the display section 411 of the telephone terminal 401 as with the first embodiment.

Further, in the second embodiment, when calculating the local time, the time calculation section 16 calculates the time about the daylight saving time and thus the case where the daylight saving time is not applied in area A, the case where areas A and B differ in the time period over which the daylight saving time is applied, etc., can also be covered.

[Third Embodiment]

A telephone terminal of a third embodiment of will be discussed. A telephone exchange system 1 including a telephone exchange 10 and a telephone terminal 401 according to the third embodiment is similar to that of the first embodiment and therefore the configuration of the system will not be discussed again in detail. In the third embodiment, however, the telephone exchange 10 sends the master time rather than the local time of area B where the telephone terminal 401 is installed to the telephone terminal 401. It is assumed that the master time varies −1 hour during the time period over which the daylight saving time is applied. It is assumed that areas A and B are the same in the time period over which the daylight saving time is applied and the standard time is set forward by one hour during the time period. In the description to follow, the telephone terminal 401 is taken as an example.

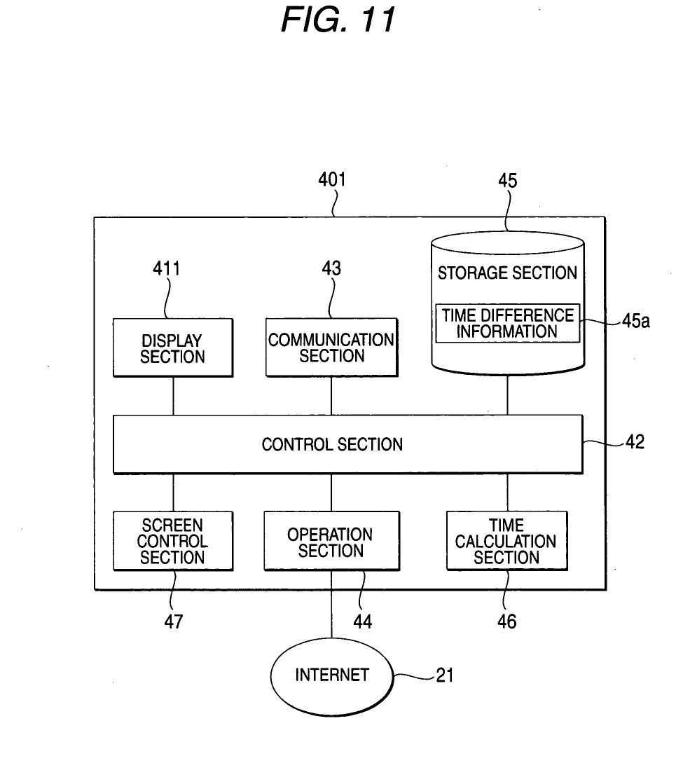

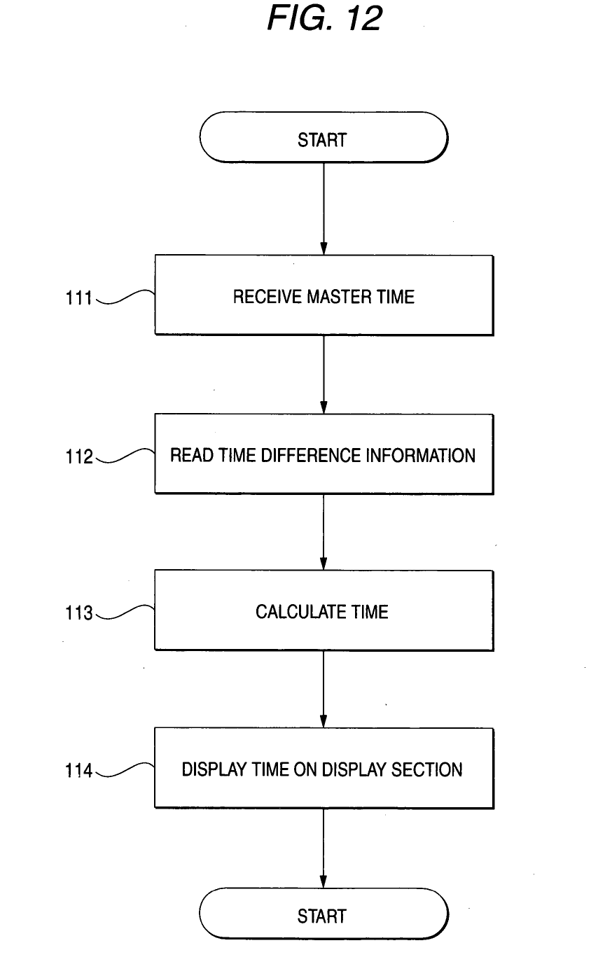

FIG. 11 is a block diagram to show the configuration of the telephone terminal 401. The telephone terminal 401 is made up of a control section 42 for performing conversation processing with the telephone exchange 10 and controlling the operation of the telephone terminal 401, a communication section 43 (a reception unit) for communicating with the telephone exchange 10, an operation section 44 for the user to enter the number involved in conversation, etc., a storage section 45 (a storage unit) for storing time difference information 45a, a time calculation section 46 (a time calculation unit) for calculating the time from the master time received from the communication section 43 and the time difference information 45a stored in the storage section 45, a display section 411 for displaying the time, and a display control section 47 for controlling the display section 411.

The communication section 43 is an interface for communicating with the telephone exchange 10. Not only ordinary conversation data, but also the master time is received through the communication section 43 from the telephone exchange 10.

The storage section 45 is a nonvolatile storage medium such as an HDD or flash memory for storing the time difference information 45a. The time difference information 45a is the time difference from the master time received from the telephone exchange 10, namely, the time difference between areas A and B. The time difference of the time difference information 45a can be set in 30-minute units ranging from +24 hours to −24 hours.

The time calculation section 46 calculates the local time of area B where the telephone terminal 401 is installed from the master time obtained from the communication section 43 and the time difference information 45a stored in the storage section 45.

The screen control section 47 displays the time on the display section 411 based on the time of area B calculated by the time calculation section 46. The screen created here is a screen as in FIG. 4.

The display section 411 is a display screen implemented as an LCD (Liquid Crystal Display), etc., and displays a screen indicating the local time created by the screen control section 47.

Next, processing of the telephone terminal 401 in displaying the time on the display section 411 will be discussed. FIG. 12 is a flowchart to show a processing flow of the telephone terminal 401 in displaying the time on the display section 411.

To begin with, the communication section 43 receives the master time from the telephone exchange 10 (step 111). The master time received here varies −1 hour during the time period over which the daylight saving time is applied, as described above. The received master time is sent to the time calculation section 46.

Next, the time calculation section 46 reads the time difference information 45a (step 112) and calculates the time in accordance with the read time difference information 45a and the master time received from the communication section 43 (step 113). For example, if the master time received at the communication section 43 is 15 hours 55 minutes on Aug. 14, 2005 and the time difference indicated by the time difference information 45a is −1 hour, the time calculated by the time calculation section 46 becomes 14 hours 55 minutes on Aug. 14, 2005.

The screen control section 47 creates a display screen as in FIG. 4 to display the time on the display section 411 and displays the time on the display section 411 (step 114).

As described above, according to the third embodiment, the time difference information 45a with respect to the master time received from the communication section 43 is previously stored in the storage section 45, whereby the correct time can be displayed on the display section 411.

Further, according to the third embodiment, the screen control section 47 of the telephone terminal 401 creates a display screen as in FIG. 4, so that the load on the telephone exchange 10 can be lightened as compared with the case where the display screen is created in the telephone exchange 10.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

According to the above-embodiments, there can be provided the telephone exchange system capable of displaying the correct time on a communication terminal when a telephone exchange and the communication terminal are installed in different regions.

What is claimed is:

1. A telephone exchange being connected to a communication terminal installed in a predetermined region through a network, comprising:
a reference time acquisition unit that acquires a reference time;
a storage unit that stores time difference information concerning a time difference between a local standard time of the standard time in the predetermined region and the reference time acquired by the reference time acquisition unit;
a local time calculation unit that calculates a local time of the time in the predetermined region based on the reference time obtained by the reference time acquisition unit and the time difference information stored in the storage unit; and
a communication unit that transmits the local time calculated by the local time calculation unit to the communication terminal.

2. The telephone exchange as claimed in claim 1 wherein the time difference information comprises information concerning a variation time period over which the local time varies from the local standard time.

3. The telephone exchange as claimed in claim 1 further comprising:
a screen control unit that creates display screen information to display the local time on a screen of the communication terminal, wherein
the communication unit that transmits the display screen information to the communication terminal.

4. The telephone exchange as claimed in claim 1 wherein the reference time is set from the communication terminal.

5. The telephone exchange as claimed in claim 1 wherein the reference time is set from a maintenance terminal connected to the telephone exchange.

6. The telephone exchange as claimed in claim 1, wherein the communication unit is connected to a plurality of communication terminals, and
wherein the storage unit stores the time difference information for each communication terminal.

7. The telephone exchange as claimed in claim 1, wherein a local time of the communication terminal is set based on the reference time acquisition unit.

8. A telephone exchange being connected to a communication terminal installed in a predetermined region through a network, comprising:
a reference time acquisition unit that acquires a reference time;
a storage unit that stores time difference information concerning the time difference between the local standard time of the standard time in the predetermined region and the reference time acquired by the reference time acquisition unit; and
a communication unit that transmits the reference time obtained by the reference time acquisition unit and the time difference obtained from the time difference information, stored in the storage unit to the communication terminal.

9. The telephone exchange as claimed in claim 8 wherein the time difference information comprises information concerning a variation time period over which the local time varies from the local standard time.

10. The telephone exchange as claimed in claim 8, wherein the communication unit is connected to a plurality of communication terminals, and
wherein the storage unit stores the time difference information for each communication terminal.

11. A communication terminal being connected to a telephone exchange for transmitting the reference time through a network and installed in a predetermined region, comprising:
a reception unit that receives the reference time from the telephone exchange;
a storage unit that stores a time difference between the reference time and the local standard time of the standard time in the predetermined region; and
a time calculation unit that calculates the local time of the time in the predetermined region based on the reference time acquired by the reception unit and the time difference stored in the storage unit.
